(19) United States
(12) Patent Application Publication
(10) Pub. No.: US 2008/0106229 A1
(43) Pub. Date: May 8, 2008

(54) Apparatus and method for detecting rotation angle of rotating body

(75) Inventors: Shin Kosaka, Toyohashi-shi (JP); Toshihisa Yamamoto, Anjo-shi (JP); Yoshitaka Hayashi, Oobu-shi (JP); Yoshiyuki Ura, Tajimi-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/907,909

(22) Filed: Oct. 18, 2007

(30) Foreign Application Priority Data
Nov. 6, 2006 (JP) 2006-300393

(51) Int. Cl. G05B 1/06; H02K 24/00

(52) U.S. Cl. 318/661; 318/490

(57) ABSTRACT

The rotation angle detection apparatus for detecting a rotation angle of a rotating body on the basis of a resolver signal outputted from a resolver mounted on the rotating body includes a first function of detecting a specific phase timing of the resolver signal, a second function of measuring a time needed for the resolver signal to reach from the specific phase timing to a peak thereof, a third function of generating a sampling timing in accordance with the time measured by the second function, a fourth function of sample-holding the resolver signal at the sampling timing to hold a peak value of the resolver signal, and a fifth function of computing the rotation angle of the rotating body on the basis of the peak value of the resolver signal held by the fourth function.

### CROSS-REFERENCE TO RELATED APPLICATION

This application is related to Japanese Patent Application No. 2006-300393 filed on Nov. 6, 2006, the contents of which are hereby incorporated by reference.

### BACKGROUND OF THE INVENTION

1. Field of the Invention

The present invention relates to an apparatus and a method for detecting a rotation angle of a rotating body by use of a resolver.

2. Description of Related Art

An electric-driven steering apparatus, which is one of important parts of a vehicle, is required to have a high reliability. Accordingly, it has been proposed to use a rotation angle detection apparatus using a resolver that has a high mechanical reliability for the purpose of detecting a steering torque of an electric-driven steering apparatus and a rotation position of an electric motor thereof. For example, refer to Japanese Patent Application laid-open No. 2003-166803. Such a rotation angle detection apparatus has a configuration that an excitation signal to be supplied to the resolver is generated by use of a microcomputer, an IC with a built-in buffer, and an exciting transistor mounted in an ECU (Electronic Control Unit), and the microcomputer detects an rotation angle of the motor through computation on the basis of peak values of a pair of resolver signals comprised of a SIN output signal and a COS output signal which the resolver outputs depending on the excitation signal. FIG. 16 is a diagram explaining how the peak value of the resolver signal is estimated in a conventional technique. As shown in FIG. 16, in the conventional technique, the resolver signal is A/D-converted at specific four points within one cycle of the excitation signal, and a CPU of the microcomputer estimates the peak value of the resolver signal on the basis of the four A/D conversion results to determined a rotation angle of the motor on the basis of the estimated peak value.

However, this conventional technique has a problem in that since the peak value of the resolver signal is estimated through computation on a plurality of AD-conversion results, the CPU load becomes large, and accordingly a high performance CPU is needed, which increases the production cost of the rotation angle detection apparatus.

### SUMMARY OF THE INVENTION

The present invention provides a rotation angle detection apparatus for detecting a rotation angle of a rotating body on the basis of a resolver signal outputted from a resolver mounted on the rotating body comprising:

a first function of detecting a specific phase timing of the resolver signal;

a second function of measuring a time needed for the resolver signal to reach from the specific phase timing to a peak thereof;

a third function of generating a sampling timing in accordance with the time measured by the second function;

a fourth function of sample-holding the resolver signal at the sampling timing to hold a peak value of the resolver signal; and

a fifth function of computing the rotation angle of the rotating body on the basis of the peak value of the resolver signal held by the fourth function.

The present invention also provides a method of detecting a rotation angle of a rotating body on the basis of a resolver signal outputted from a resolver mounted on the rotating body comprising:

a first step of detecting a specific phase timing of the resolver signal;

a second step of measuring a time needed for the resolver signal to reach from the specific phase timing to a peak thereof;

a third step of generating a sampling timing in accordance with the time measured in the second step;

a fourth step of sample-holding the resolver signal at the sampling timing to hold a peak value of the resolver signal; and

a fifth step of computing the rotation angle of the rotating body on the basis of the peak value of the resolver signal held in the fourth step.

The present invention also provides a method of detecting a rotation angle of a rotating body on the basis of a pair of resolver signals outputted from a resolver mounted on the rotating body, the resolver signals having a predetermined phase difference from each other, comprising:

a first step of selecting one of the pair of the resolver signals, which has a larger amplitude;

a second step of detecting a specific phase timing of the selected resolver signal;

a third step of measuring a time needed for the selected resolver signal to reach from the specific phase timing to a peak thereof;

a fourth step of generating a sampling timing in accordance with the time measured in the third step;

a fifth step of sample-holding the pair of the resolver signals at the sampling timing to hold peak values of the pair of the resolver signals; and

a sixth step of computing the rotation angle of the rotating body on the basis of the peak values of the pair of the resolver signals held in the fifth step.

According to the present invention, it is possible to reduce the CPU load at the time of detecting a rotation angle of a rotating body on the basis of a resolver signal outputted from a resolver mounted on the rotating body.

Other advantages and features of the invention will become apparent from the following description including the drawings and claims.

### BRIEF DESCRIPTION OF THE DRAWINGS

In the accompanying drawings:

FIG. 1 is a block diagram showing an overall structure of a rotation angle detection apparatus according to an embodiment of the invention;

FIG. 2 is a diagram showing waveforms of an excitation signal, a SIN output signal, and a COS output signal;

FIG. 3 is a block diagram showing an overall structure of a sampling signal generating circuit;

FIG. 4 is a circuit diagram showing structures of a 4V-rising-crosspoint detecting section, a 1-cycle time measuring counter, and a ¼-cycle time buffer;

FIG. 5 is a circuit diagram showing structures of a 2.5V-crosspoint detecting section, a peak hold timing correcting section, and a peak hold timing measuring section;

FIG. 6 is a circuit diagram showing a structure of a sampling time control section;

FIG. 7 is a circuit diagram showing a structure of a sample-hold circuit;

FIG. 8 is a graph showing relationship among an excitation signal waveform, a count value of the 1-cycle time measuring counter, and a content of the ¼-cycle time buffer;

FIG. 9 is a graph showing relationship between a resolver signal waveform and a count value of the peak hold timing counter;

FIG. 10 is a graph showing relationship between the excitation signal waveform and a sampling signal;

FIG. 11 is a graph showing relationship between the resolver signal waveform and a sample hold point when an electric angle is between 0 degrees and 180 degrees;

FIG. 12 is a graph showing relationship between the resolver signal waveform and a sample hold point when the electric angle is between 180 degrees and 360 degrees;

FIG. 13 is a graph showing relationship between the resolver signal waveform and a peak-hold signal;

FIG. 14 is a flowchart explaining the operation of the rotation angle detection apparatus of the invention;

FIG. 15 is a flowchart explaining the operation of a variant of the rotation angle detection apparatus of the invention; and

FIG. 16 is a diagram explaining how a peak value of the resolver signal is estimated in a conventional technique.

### PREFERRED EMBODIMENTS OF THE INVENTION

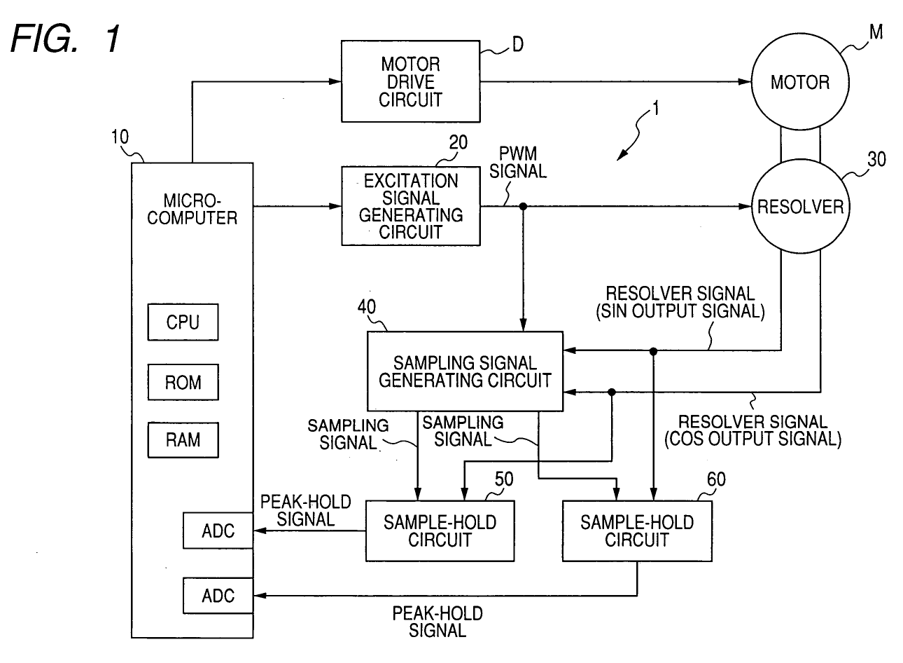

FIG. 1 is a block diagram showing an overall structure of a rotation angle detection apparatus 1 according to an embodiment of the invention.

The rotation angle detection apparatus 1 includes a microcomputer 10, an excitation signal generating circuit 20, a resolver 30, a sampling signal generating circuit 40, and sample-hold circuits 50, 51.

The microcomputer 10, which includes therein a CPU, a ROM, a RAM and A/D converters, performs a process of outputting a PWM signal (Pulse Width Modulation signal) used for generating a sinusoidal excitation signal to the excitation signal generating circuit 20, a process of capturing a peak-hold value of a resolver signal from the sample-hold circuit 50 through the A/D converter, and a process of computing a rotation angle of a motor M on the basis of the captured peak-hold value of the resolver signal. Although the microcomputer 10 also performs a process of driving the motor M through a motor drive circuit D, explanation on this process is omitted here, because it is not relevant to the invention.

The excitation signal generating circuit 20 generates a sinusoidal voltage as the excitation signal in accordance with the PWM signal received from the microcomputer 10.

The resolver 30 includes a not-shown excitation winding wound around a rotor fixed to a rotation shaft of the motor M and applied with the excitation signal supplied from the excitation signal generating circuit 20, and a not-shown pair of output windings wound around a stator of the motor M so as to have an electrical distance of 90° to each other. These output windings output, as the resolver signals, a SIN output signal and a COS output signal having a phase difference of 90° from each other.

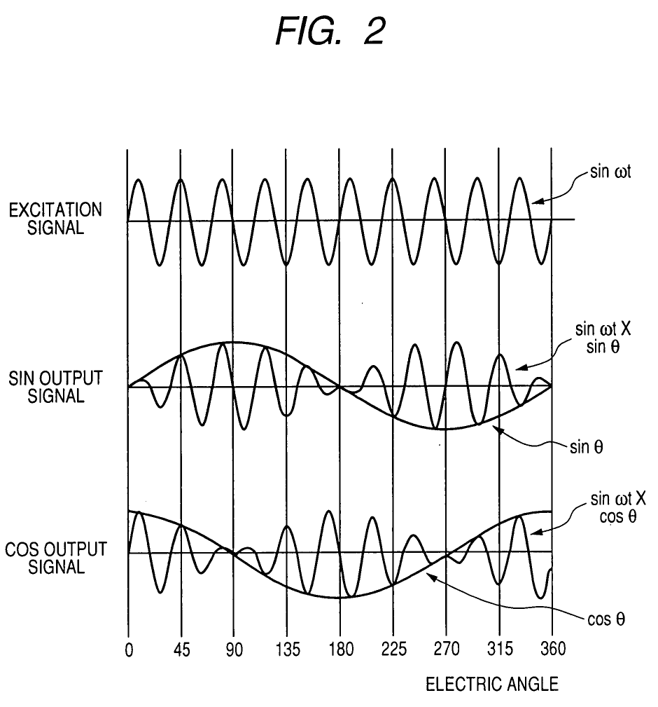

FIG. 2 shows waveforms of the excitation signal sinωt, the SIN output signal sinωt×sinθ, and the COS output signal sinωt ×cosθ, when the phase angle of the excitation signal is ωt, and the electrical angle (rotation angle) of the motor M is θ.

The sampling signal generating circuit 40 generates a sampling signal commanding the sample-hold circuits 50, 51 to sample-hold the peak values of the resolver signals on the basis of the excitation signal received from the excitation signal generating circuit 20 and the resolver signals (SIN output signal and COS output signal) received from the resolver 30.

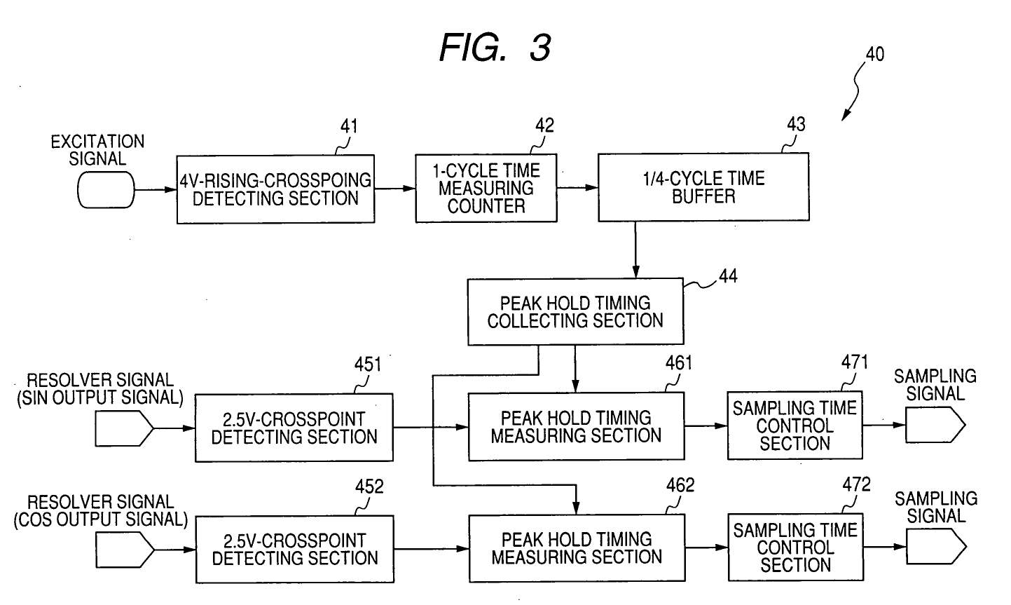

As shown in FIG. 3, the sampling signal generating circuit 40 includes a 4V-rising-crosspoint detecting section 41, a 1-cycle time measuring counter 42, a ¼-cycle time buffer 43, a peak hold timing correcting section 44, 2.5V-crosspoint detecting sections 451, 452, a peak hold timing measuring section 461, 462, and sampling time control sections 471, 472.

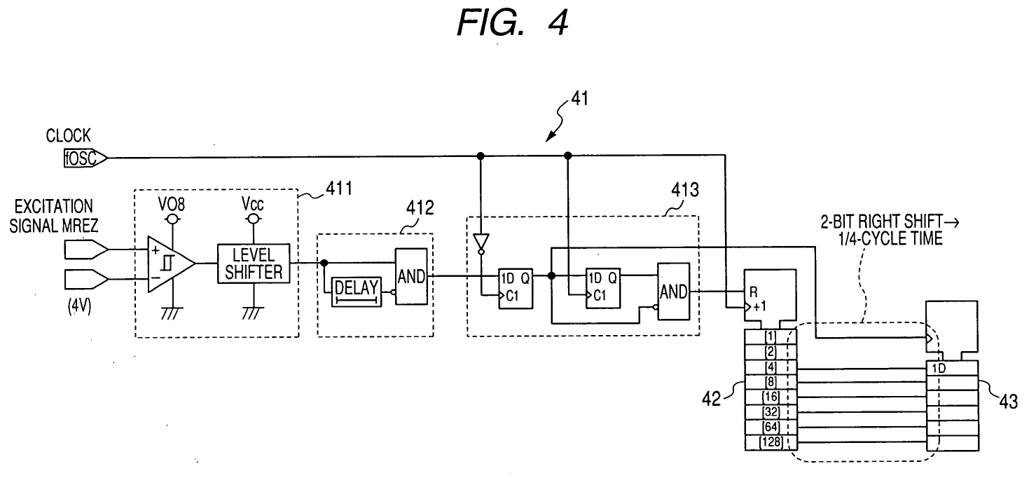

The 4V-rising crosspoint detecting section 41 is a digital logic circuit for detecting a rising crosspoint at which the excitation signal rises to its center voltage of 4V. As shown in FIG. 4, the 4V-rising-crosspoint detecting section 41 includes a sinusoidal wave/rectangular wave converting section 411, a rising edge detecting section 412, and a synchronizing section 413.

The sinusoidal wave/rectangular wave converting section 411 includes a comparator circuit, and a level shifter for level-shifting an output voltage of the comparator circuit. The comparator circuit receives the excitation signal MREZ outputted from the excitation signal generating circuit 20 at its non-inverting input terminal, and receives a threshold voltage of 4V at its inverting input terminal. Accordingly, when the excitation signal is equal to or above 4V, the output of the comparator circuit is at “H” level, and otherwise it is at “L” level. Consequently, when the excitation signal changes from below 4V to above 4V, the output of the comparator circuit changes from “L” level to “H” level.

The output of the sinusoidal wave/rectangular wave converting section 411 is divided into two in the rising edge detecting section 412, one of which being inputted to an AND circuit as it is, the other of which being inputted to the AND circuit through a delay circuit after being inverted. The AND circuit is a circuit which outputs a logical product of its two inputs. Accordingly, the AND circuit outputs a pulse signal when the output of the sinusoidal wave/rectangular wave converter section 411 rises from “L” level to “H” level. By detecting this pulse signal, it is possible to reliably detect the 4V-rising crosspoint of the excitation signal.

The synchronizing section 413, which is constituted by two D-flipflops and an AND circuit, synchronizes the pulse signal outputted from the rising edge detecting circuit 412 to a clock fOSC, and outputs the synchronized pulse signal.

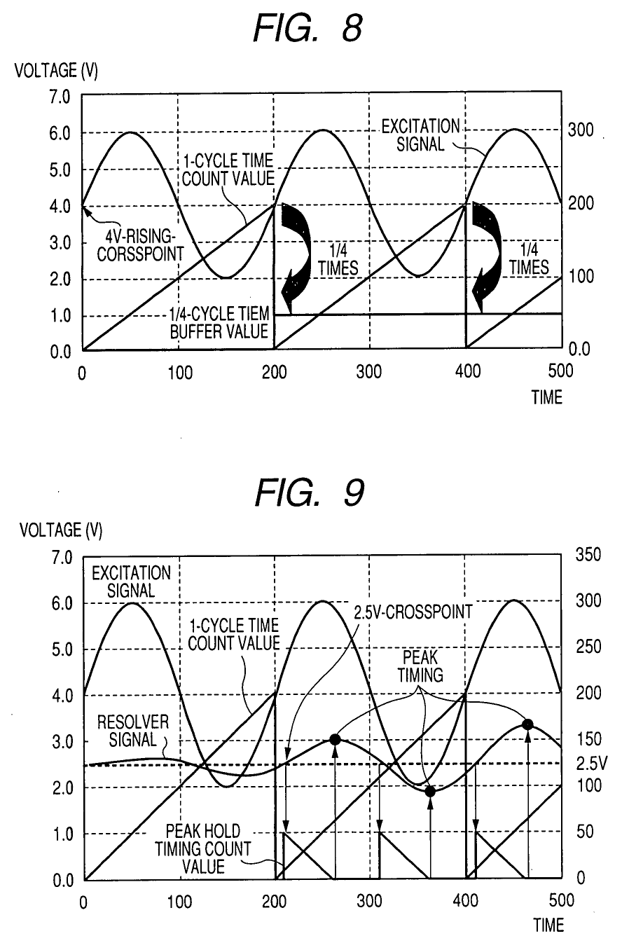

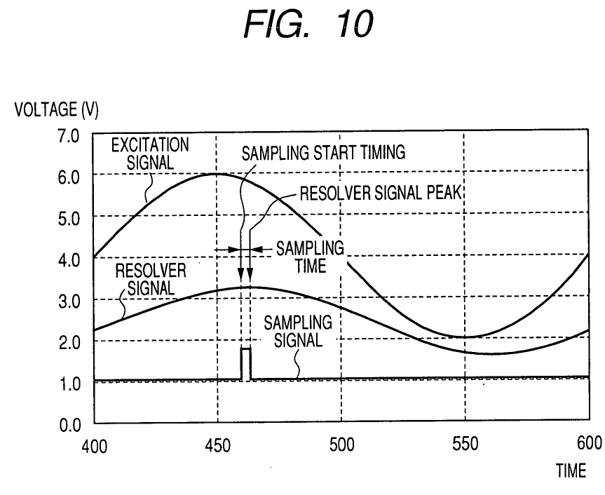

As shown in FIG. 4, the 1-cycle time measuring counter 42, which is an up-counter, is zero-cleared when it receives, as a reset signal, the pulse signal indicative of detection of the 4V-rising crosspoint of the excitation signal outputted from the 4V-rising-crosspoint detecting section 41, and starts to up-count the clock until it receives again the pulse signal indicative of detection of the next succeeding 4V-rising crosspoint of the excitation signal in order to measure a 1-cycle time of the excitation signal. In FIG. 8, there is shown relationship among the waveform of the excitation signal, the count value of the 1-cycle time measuring counter 42, and the content of the ¼-cycle time buffer 43.

As shown in FIG. 4, the ¼-cycle time buffer 43 performs a 2-bit right shift operation (division by 4) on the count value of the 1-cycle time measuring counter 42 indicating 1-cycle time of the excitation signal in order to obtained ¼-cycle time of the resolver signal. Since the 1-cycle time of the resolver signal is equal to the 1-cycle time of the excitation signal, the ¼-cycle time of the resolver signal can be obtained as a value of the 1-cycle time of the excitation signal divided by 4.

The peak hold timing correcting section 44 subtracts a peak hold timing correction value from the content of the ¼-cycle time buffer indicating the ¼-cycle time of the resolver signal in order to determine a sampling start timing (peak hold timing) with respect to a 2.5V-crosspoint at which the resolver signal-crosses its center voltage of 2.5V. The peak hold timing correction value is a value corresponding to a time needed to carry out the sampling of the peak value. By subtracting the peak hold timing correction value from the count value corresponding to the ¼-cycle time of the excitation signal, the peak hold start timing is moved up by the time needed to carry out the sampling of the peak value, so that the peak hold end timing agrees with the peak of the resolver signal.

Each of the 2.5V-crosspoint detecting sections 451, 452 is a digital logic circuit for detecting the 2.5V-cross point of the resolver signal. More specifically, the detecting section 451 is for detecting the 2.5V-crosspoint of the SIN output signal, and the detecting section 452 is for detecting the 2.5V-crosspoint of the COS output signal. Since the detecting sections 451, 452 have the same structure, only the detecting sections 451 is explained in detail in the following.

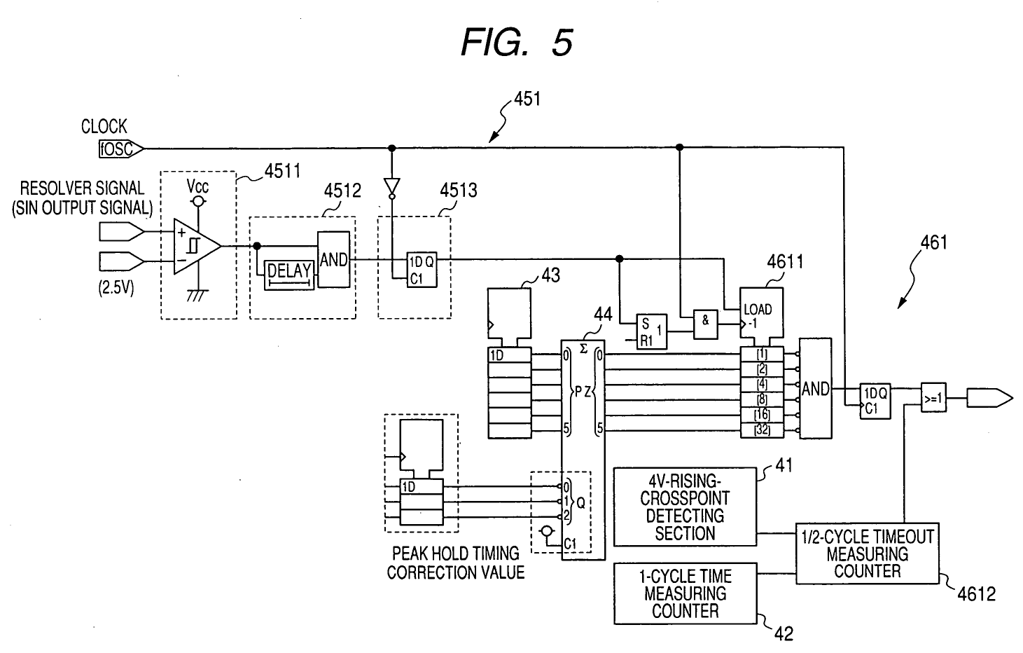

As shown in FIG. 5, the 2.5V-crosspoint detecting section 451 includes a sinusoidal wave/rectangular wave converting section 4511, a both-edge detecting section 4512, and a synchronizing section 4513.

The sinusoidal wave/rectangular wave converting section 4511 includes a comparator circuit which receives the resolver signal (SIN output signal) outputted from the resolver 30 at its non-inverting input terminal, and receives a threshold voltage of 2.5V at its inverting input terminal. Accordingly, when the resolver signal is equal to or above 2.5V, the output of the comparator circuit is at “H” level, and otherwise, it is at “L” level. Consequently, when the resolver signal changes from below 2.5 V to above 2.5V, the output of the sinusoidal wave/rectangular wave converting section 4511 changes from the “L” level to “H” level, and when the resolver signal changes from above 2.5 V to below 2.5V, the output of the sinusoidal wave/rectangular wave converting section 4511 changes from “H” level to “L” level.

The output of the sinusoidal wave/rectangular wave converting section 4511 is divided into two in the both-edge detecting section 4512, one of which being inputted to an coincidence circuit as it is, the other of which being inputted to the coincidence circuit through a delay circuit after being inverted. The coincidence circuit is a circuit which outputs “H” level when its two inputs have the same level. Accordingly, the coincidence circuit outputs a pulse signal when the output of the sinusoidal wave/rectangular wave converting section 4511 rises from “L” level to “H” level, or falls from “H” level to “L” level. By detecting this pulse signal, it is possible to reliably detect the 2.5V-cross point of the resolver signal.

The synchronizing section 4513, which is constituted by a D-flipflop, synchronizes the pulse signal outputted from the both-edge detector circuit 4512 to the clock fOSC, and outputs the synchronized pulse signal.

As shown in FIG. 5, the peak hold timing measuring section 461 includes a peak hold timing measuring counter 4611 and a ½-cycle timeout measuring counter 4612.

The peak hold timing measuring counter 4611, which is a down counter, is configured to be set to an initial value which is equal to the count value corrected by the peak hold timing correction section 44, that is, the value obtained by subtracting the peak hold timing correction value from the count value corresponding to the ¼-cycle time of the excitation signal, and to down counts from the time of detection of the 2.5V-crosspoint of the resolver signal by the 2.5V-crosspoint detecting section 451 to the time when its count value becomes 0, in order to measure the time elapsed between the 2.5V-crosspoint of the resolver signal and the peak hold start timing. In FIG. 9, there is shown relationship between the waveform of the resolver signal, and the count value of the peak hold timing measuring counter 4611.

The ½-cycle timeout measuring counter 4612, which is a down counter, is configured to be set to an initial value which is equal to the count value of the 1-cycle time measuring counter 42, and to down counts from the time of detection of the 4V-rising-crosspoint of the excitation signal by the 4V-rising-crosspoint detecting section to the time when its count value becomes 0, in order to measure the elapsed time between the 4V-rising-crosspoint of the excitation signal and the ½-cycle time of the excitation signal (timeout time).

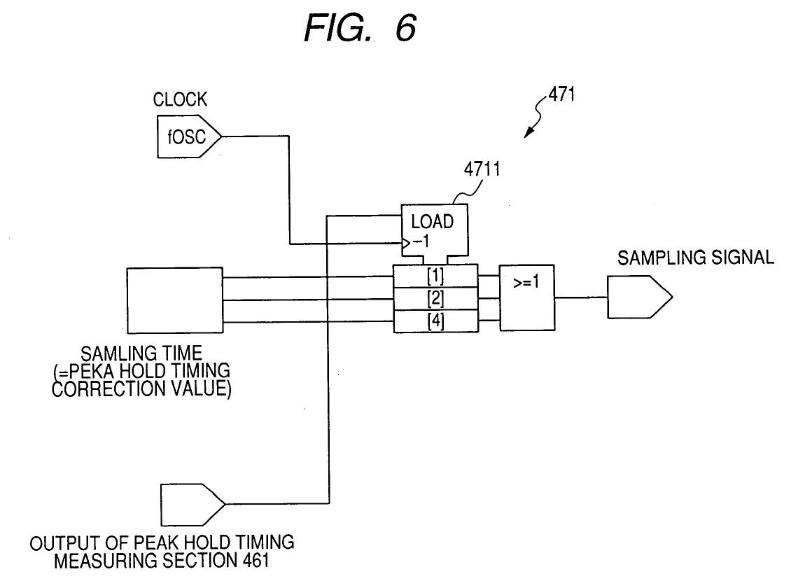

As shown in FIG. 6, the sampling time control section 471 includes a down counter as a sampling time control counter 4711. This sampling time control counter 4711 is set to a count value corresponding to a sampling time length equal to the above described peak hold timing correction value upon receiving an “H” level signal from the peak hold timing measuring section 461, and outputs the sampling signal of “H” level while it down counts until its count value becomes 0.

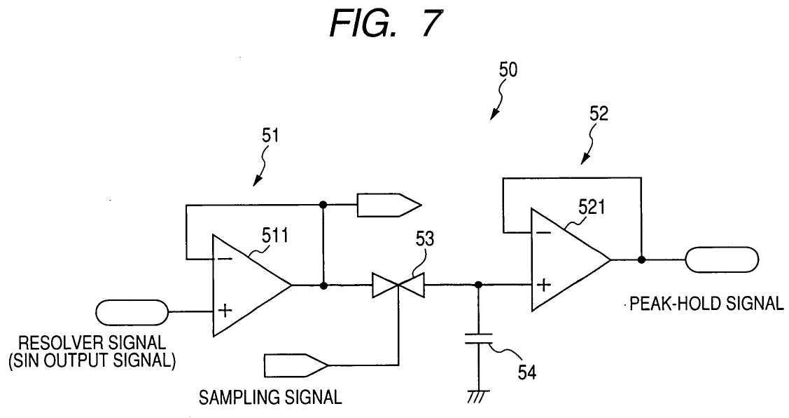

As shown in FIG. 7, the sample-hold circuit 50 includes an input-side buffer 51 having an operational amplifier 511, and an output-side buffer 52 having an operational amplifier 521. Between the operational amplifiers 511 and 512, there is connected a switch 53 on/off controlled by the sampling signal supplied from the sampling signal generating circuit 40, and a grounded capacitor 54. The operational amplifier 511 of the input-side buffer 51 is applied with the resolver signal (SIN output signal) outputted from the resolver 30 at its non-inverting input terminal. When the sampling signal becomes “H” level, the switch 53 is closed, and as a result the capacitor 54 is charged. When the sampling signal becomes “L” level, the switch 53 is opened, the terminal voltage of the capacitor 54 is kept constant, because no charging current flows into the capacitor 54. The voltage held in the capacitor 54 is outputted from the operational amplifier 521 of the output-side buffer 52 as a peak-hold signal. Since the sample-hold circuit 60 differs from the sample hold circuit 50 only in that it receives the COS output signal as the resolver signal, explanation on the sample-hold circuit 60 is omitted.

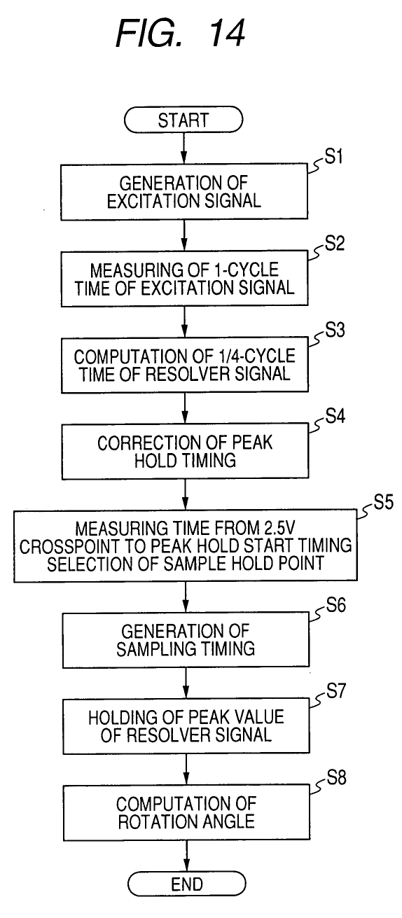

Next, explanation is made as to the process of detection of the electric angle of the motor M by the rotation angle detection apparatus 1 with reference to the flowchart of FIG. 14. In FIG. 1, when the microcomputer 10 sends the PWM signal to the excitation signal generating circuit 20, the excitation signal generating circuit 20 generates a sinusoidal voltage as the excitation signal (step S1).

In the sampling signal generating circuit 40 shown in FIGS. 3, 4, the 1-cycle time of the excitation signal or the time between the 4V-rising-crosspoint and the next succeeding 4V-rising-crosspoint of the excitation signal is measured by the 4V-rising-crosspoint detecting section 41 and the 1-cycle time measuring counter 42 (step S2). The ¼-cycle time buffer 43 obtains the ¼-cycle time of the excitation signal (or ¼-cycle time of the resolver signal) by performing a 2-bit right shift operation on the count value of the 1-cycle time measuring counter 42 (step S3).

The peak hold timing correcting section 44 determines the sampling start timing (peak hold timing) of the peak value with respect to the 2.5V-crosspoint of the resolver signal by subtracting the peak hold timing correction value from the count value corresponding to the ¼-cycle time of the excitation signal read from the ¼-cycle time buffer (step S4).

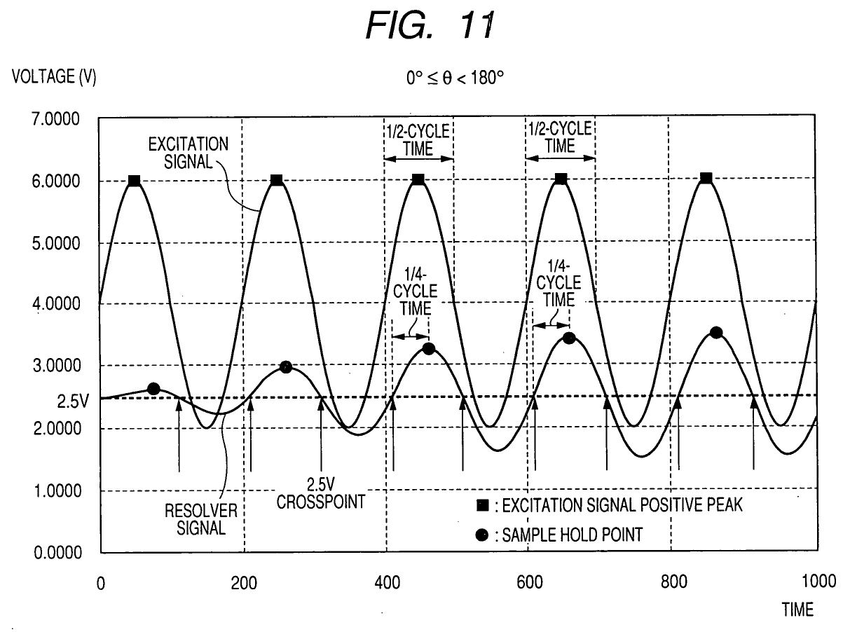

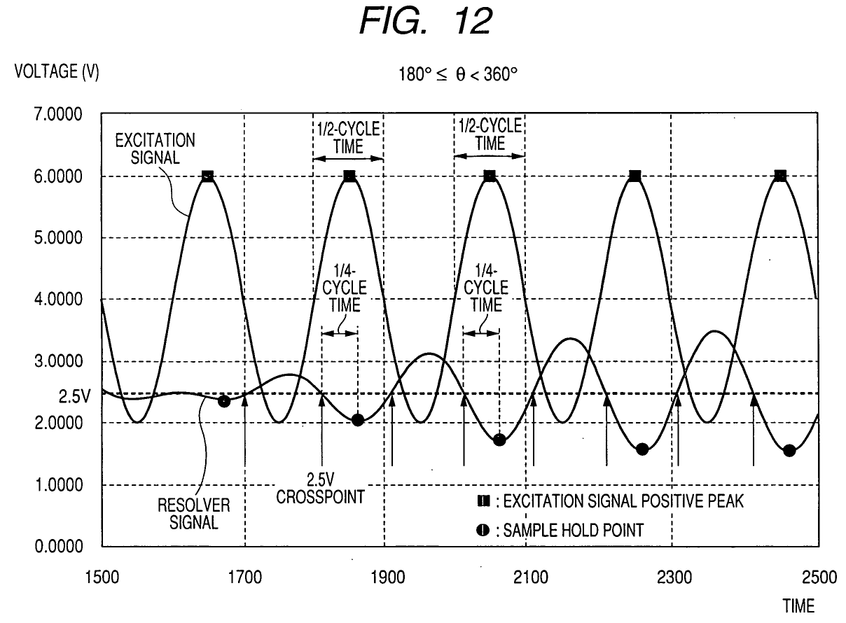

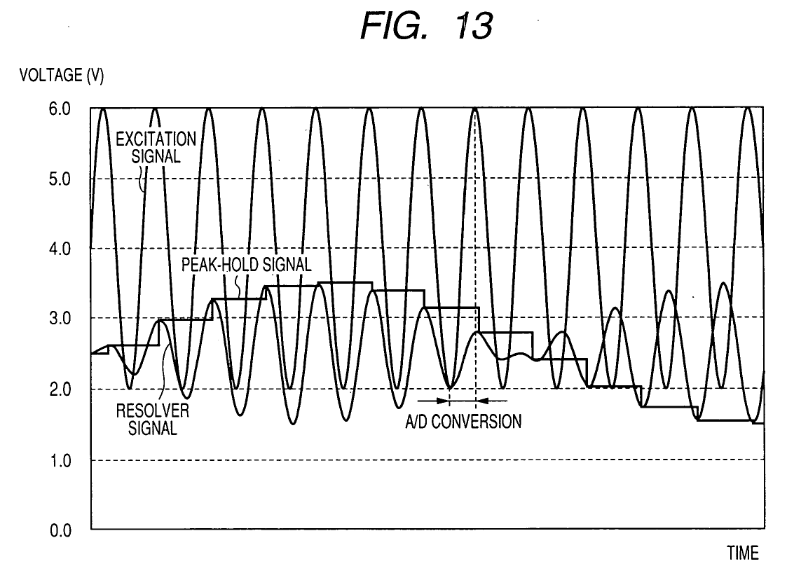

On the other hand, the 2.5V-crosspoint detecting sections 451, 452 detects the crosspoints of the resolver signals (SIN output signal, COS output signal). Each of the peak hold timing measuring sections 461, 462 is set to its initial value equal to the value outputted from the peak hold timing correcting section 44, that is, the count value corresponding to the ¼-cycle time of the excitation signal is subtracted by the peak hold timing correction value, and down counts from the time of detection of the 2.5V-crosspoint of the resolver signal by the 2.5V-crosspoint detecting section 451 or 452 to the time when its count value becomes 0, in order to measure the elapsed time between the 2.5V-crosspoint of the resolver signal and the peak hold start timing (step S5). Concurrently with the above, the ½-cycle timeout counter 4612 is set to its initial value equal to the count value corresponding to the ½-cycle time of the excitation signal outputted from the 1-cycle time measuring counter 42, and down counts from the time of detection of the 4V-rising-crosspoint of the excitation signal by the 4V-rising-crosspoint detecting section 41 to the time when its count value becomes 0, in order to measure the elapsed time between the 4V-rising-crosspoint of the excitation signal and the ½-cycle time of the excitation signal (timeout time). Each of the peak hold timing measuring sections 461, 462 outputs “H” level when the output of the peak hold timing measuring counter 4611 is at “H” level and the output of the ½-cycle timeout measuring counter 4612 is at “H” level (that is, within the timeout time). Accordingly, as shown in FIG. 11, in a range of 0°<electric angle ≦180°, the positive side peak of the resolver signal appearing immediately after the positive side peak of the excitation signal is selected as a sample hold point. On the other hand, in a range of 180°<electric angle≦360°, the negative side peak of the resolver signal appearing immediately after the positive side peak of the excitation signal is selected as a sample hold point.

Each of the sampling time control sections 471, 472 is set to its initial value equal to the count value corresponding to the sampling time length upon receiving an “H” level signal from the peak hold timing measuring section 461 or 462, and outputs the sampling signal of “H” level while it down counts the clock fOSC until its count value becomes 0 (step S6).

Each of the sample-hold circuits 50, 60 sample-holds the peak value of the resolver signal (SIN output signal or COS output signal) while it receives an “H” level signal as the sampling signal from the sampling signal generating circuit 40 (step S7).

The microcomputer 10 performs the A/D conversion while the excitation signal is rising to obtain the peak-hold signal (peak-hold value of the resolver signal) through the sample-hold circuits 50, 60 (refer to FIG. 13), and computes the rotation angle of the motor M (electric angle theta of the motor M) on the basis of the obtained peak-hold value (step S8). The electric angle theta can be obtained by the equation of tanθ=the peak-hold value of the SIN output signal/the peak-value of the COS output signal.

As understood from the above explanation, in this embodiment, each of the 2.5V-crosspoint detecting sections 451, 452 detects the 2.5V-crosspoint of the resolver signal, each of the peak hold timing measuring sections 461, 462 measures the peak hold timing (the timing at which the resolver signal reaches around its peak with respect to the 2.5V-crosspoint), and each of the sampling time control sections 471, 472 generates the sampling signal (sampling timing) in accordance with the result of the timing measurement by the peak hold timing measuring section 461 or 462. Each of the sample-hold circuits 50, 60 sample-holds the peak value of the resolver signal in accordance with the sampling signal, and the CPU of the microcomputer 10 captures the peak-hold value of the resolver signal from the sample-hold circuit 50 or 60 through the A/D converter, and computes the rotation angle on the basis of the peak-hold value. The sampling signal generating circuit including the 2.5V-crosspoint detecting sections 451, 452, peak hold timing measuring sections 461, 462, and the sampling time control sections 471, 472 is implemented by digital logic circuits, and the sample-hold circuits 50, 60 are implemented by a simple circuit including the capacitor 54. Accordingly, in this embodiment, since the peak value of the resolver signal necessary to compute the rotation angle can be obtained by hardware configuration, the CPU load can be substantially reduced compared to the conventional configuration in which the CPU of the microcomputer estimates the peak value of the resolver signal.

The 4V-rising-crosspoint detecting section 41 and the 1-cycle time measuring counter 42 measure the cycle period of the sinusoidal excitation signal generated by the excitation signal generating circuit 20, the ¼-cycle time buffer measures the ¼-cycle time of the excitation signal which is a time taken for the resolver signal to reach from the 2.5V-crosspoint to its peak on the basis of the cycle period of the excitation signal, and each of the sampling time control sections 471, 472 generates the sampling signal in accordance with the peak hold timing (the timing at which the resolver signal reaches from the 2.5V-crosspoint around its peak) measured by the peak hold timing measuring section 461 or 462. The timing at which the resolver signal crosses its center voltage can be detected easily by an operational amplifier or the like. Since the resolver signal is a product of the sinusoidal excitation signal and a sine value or a cosine value of the rotation angle of the motor M, the resolver signal crosses its center voltage at a specific phase timing at which the motor M is in a phase position of 0° or 180°, and the resolver signal reaches its peak after an elapse of ¼-cycle time of the excitation signal from this phase timing. Accordingly, each of the sampling time control sections 471, 472 can reliably generate the sampling signal in time with the timing at which the resolver signal reaches from the phase timing of 0° or 180° measured by the peak hold timing measuring section 461 or 462 to its peak on the basis of the ¼-cycle time of the excitation signal. Since the 4V-rising-crosspoint detecting section 41, the 1-cycle time measuring counter 42, and the ¼-cycle time buffer 43 are each constituted by a digital logic circuit, the CPU load of the microcomputer 10 can be made small.

The peak of the resolver signal appears immediately after the positive side peak of the excitation signal and also immediately after the negative side peak of this excitation signal. However, only the peak appearing immediately after the positive side peak of the excitation signal is needed to compute the rotation angle. In this embodiment, since the ½-cycle timeout counter 4612 is provided to enable each of the sampling time control section 471, 472 to generate the sampling timing within a period of the ½-cycle time of the excitation signal starting from the 4V-rising-crosspoint of the excitation signal, the sample-hold circuits 50, 60 can sample-hold only the peak value of the resolver signal appearing immediately after the positive side peak of the excitation signal.

The peak hold timing correcting section 44 corrects the sampling timing in accordance with the time length needed for the sample-hold circuits 50, 60 to sample-hold the resolver signal in such a way that the sampling start timing is earlier than the timing at which the resolver signal takes its peak by the time needed to carry out the sampling, so that the resolver signal takes its value at the sample hold end timing. This makes it possible for the sample-hold circuits 50, 60 to accurately sample-hold the peak value of the resolver signal. Accordingly, the CPU of the microcomputer 10 can accurately compute the rotation angle on the basis of the accurately sampled-held peak value.

It is a matter of course that various modifications can be made to the above described embodiment.

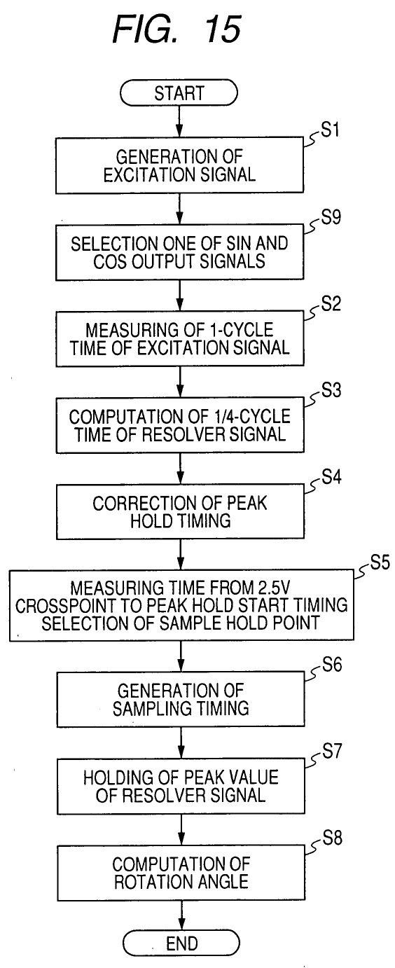

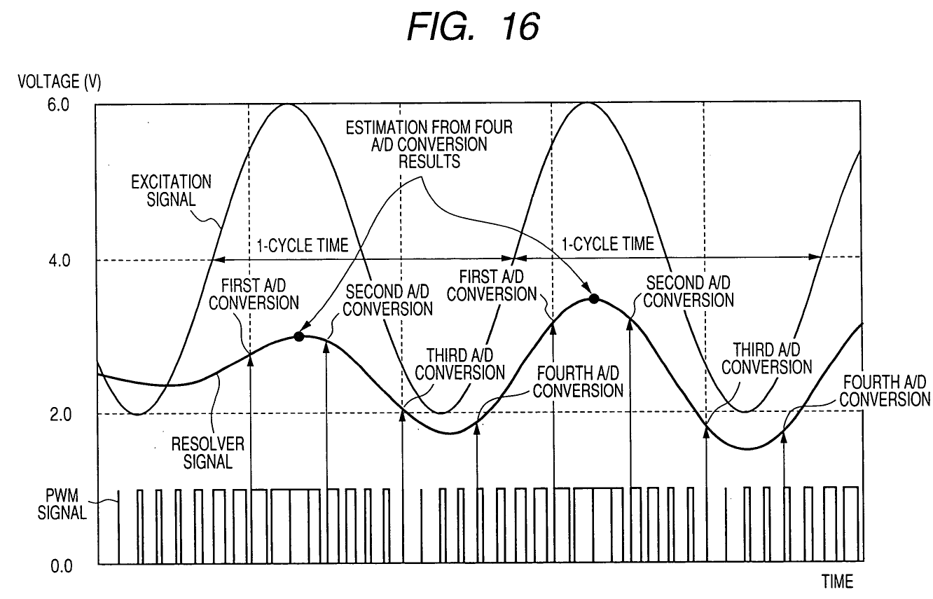

As shown in the flowchart shown in FIG. 15, the embodiment may be so configured to perform further a resolver signal selecting step (step S9) of selecting one of the SIN output signal and the COS output signal, which has a larger amplitude. In this case, the above explained sample hold step is modified to sample-hold the peak voltage of both the SIN and COS output signals. The reason for the above is as follows.

The rotation angle detection apparatus is required to be capable of detecting the peak position of the resolver signal and sample-holding the peak value even when the amplitude of the resolver signal is small, however, there is a possibility that the resolver signal is sample-held at a wrong position if the amplitude of the resolver signal is too small. This problem can be dealt with by using the fact that the SIN output signal and the COS output signal are shifted in phase by 900 from each other, and accordingly they do not become small at the same time. This configuration makes it possible to prevent the peak position of the resolver signal from being misdetected or undetected even when the amplitude of the resolver signal is considerably small.

The above explained preferred embodiments are exemplary of the invention of the present application which is described solely by the claims appended below. It should be understood that modifications of the preferred embodiments may be made as would occur to one of skill in the art.

What is claimed is:

1. A rotation angle detection apparatus for detecting a rotation angle of a rotating body on the basis of a resolver signal outputted from a resolver mounted on said rotating body comprising:
a first function of detecting a specific phase timing of said resolver signal;
a second function of measuring a time needed for said resolver signal to reach from said specific phase timing to a peak thereof;
a third function of generating a sampling timing in accordance with said time measured by said second function;
a fourth function of sample-holding said resolver signal at said sampling timing to hold a peak value of said resolver signal; and
a fifth function of computing said rotation angle of said rotating body on the basis of said peak value of said resolver signal held by said fourth function.

2. The rotation angle detection apparatus according to claim 1, further comprising a sixth function of generating a sinusoidal excitation signal to be supplied to said resolver, and a seventh function of measuring a cycle period of said excitation signal, said second function of computes said time needed for said resolver signal to reach from said specific phase timing to said peak thereof on the basis of said cycle period of said excitation signal measured by said seventh function.

3. The rotation angle detection apparatus according to claim 2, wherein said second function computes a ¼-cycle time of said excitation signal, said first function detects, as said specific phase timing, a timing at which said resolver signal crosses a center voltage thereof, and said third function generates said sampling timing in accordance with the basis of said ¼-cycle time of said excitation signal and said timing at which said resolver signal crosses said center voltage thereof.

4. The rotation angle detection apparatus according to claim 3, wherein said third function generates said sampling timing within a period of a ½-cycle time of said excitation signal starting from a timing at which said excitation signal rises from said center voltage thereof.

5. The rotation angle detection apparatus according to claim 4, further comprising an eighth function of correcting said sampling timing depending on a time length needed for said fourth function to carry out a sample-hold operation of said resolver signal.

6. A method of detecting a rotation angle of a rotating body on the basis of a resolver signal outputted from a resolver mounted on said rotating body comprising:
a first step of detecting a specific phase timing of said resolver signal;
a second step of measuring a time needed for said resolver signal to reach from said specific phase timing to a peak thereof;
a third step of generating a sampling timing in accordance with said time measured in said second step;
a fourth step of sample-holding said resolver signal at said sampling timing to hold a peak value of said resolver signal; and
a fifth step of computing said rotation angle of said rotating body on the basis of said peak value of said resolver signal held in said fourth step.

7. The method according to claim 6, further comprising a sixth step of generating a sinusoidal excitation signal to be supplied to said resolver, a seventh step of measuring a cycle period of said excitation signal, said second step computes said time needed for said resolver signal to reach from said specific phase timing to said peak thereof on the basis of said cycle period of said excitation signal measured in said seventh step.

8. The method according to claim 7, wherein said second step computes a ¼-cycle time of said excitation signal, said first step detects, as said specific phase timing, a timing at which said resolver signal crosses a center voltage thereof, and said third step generates said sampling timing in accordance with said ¼-cycle time of said excitation signal and said timing at which said resolver signal crosses said center voltage thereof.

9. The method according to claim 8, wherein said third step generates said sampling timing within a period of a ½-cycle time of said excitation signal starting from a timing at which said excitation signal rises from said center voltage thereof.

10. The method according to claim 9, further comprising an eighth step of correcting said sampling timing depending on a time length needed for said fourth step to carry out a sample-hold operation on said resolver signal.

11. A method of detecting a rotation angle of a rotating body on, the basis of a pair of resolver signals outputted from a resolver mounted on said rotating body, said resolver signals having a predetermined phase difference from each other, comprising:
a first step of selecting one of said pair of said resolver signals, which has a larger amplitude;
a second step of detecting a specific phase timing of said selected resolver signal;
a third step of measuring a time needed for said selected resolver signal to reach from said specific phase timing to a peak thereof;
a fourth step of generating a sampling timing in accordance with said time measured in said third step;
a fifth step of sample-holding said pair of said resolver signals at said sampling timing to hold peak values of said pair of said resolver signals; and
a sixth step of computing said rotation angle of said rotating body on the basis of said peak values of said pair of said resolver signals held in said fifth step.
